(19) United States
(12) Patent Application Publication
(10) Pub. No.: US 2012/0008017 A1
(43) Pub. Date: Jan. 12, 2012

(54) IMAGE SENSOR AND PIXEL CORRECTION METHOD

(76) Inventors: Yeon-U JEONG, Gyeonggi-do (KR); Kwan-Youl Lee, Gyeonggi-do (KR); Geon-Pyo Kim, Gyeonggi-do (KR); Nam-Hyun Kim, Gyeonggi-do (KR)

(21) Appl. No.: 12/982,498

(22) Filed: Dec. 30, 2010

(30) Foreign Application Priority Data
Jul. 7, 2010 (KR) 10-2010-0065406
Jul. 7, 2010 (KR) 10-2010-0065407

(51) Int. Cl. H04N 9/64; H04N 5/217

(52) U.S. Cl. 348/246; 348/241; 348/E09.037; 348/E05.079

(57) ABSTRACT

An image sensor includes a corrector configured to receive a bayer raw data of a pixel array and output a corrected pixel value by correcting a dead pixel occurring in the pixel array, a memory configured to store the corrected pixel value updated in real-time, and a controller configured to control the real-time updating of the corrected pixel value to be stored in the memory, wherein when the corrector corrects the dead pixel in response to a clock, the corrector uses the corrected pixel value which is updated and stored in the memory in response to a previous cycle of the clock.

### CROSS-REFERENCE TO RELATED APPLICATIONS

The present application claims priority of Korean Patent Application Nos. 10-2010-0065406 and 10-2010-0065407, filed on Jul. 7, 2010, individually, which are incorporated herein by reference in their entirety.

### BACKGROUND OF THE INVENTION

Exemplary embodiments of the present invention relate to a semiconductor device, and more particularly, to an image signal processing (ISP) of an image sensor (IS) in a semiconductor device.

Generally, an image sensor is a semiconductor device that transforms analog optical signals into electrical signals. At present, the function of taking a picture is being popularized, as camera module is mounted not only on a digital camera but also terminals such as a mobile phone, a smart phone, a Personal Digital Assistant (PDA) and so forth. In these camera systems, an image sensor may includes a plurality of pixels arrayed in a two-dimensional structure. A pixel transforms an optical signal, which is an analog signal, into an electrical signal according to its luminance.

The image sensor is applied to a variety of fields from home appliances, such as a digital camera and a mobile phone, to an endoscope used at the hospital, a telescope of a satellite revolving around the Earth, and so forth. Among diverse kinds of image sensors, an image sensor fabricated based on a CMOS technology has a simple operation scheme and may be realized in diverse scanning schemes. Since a signal processing circuit of the image sensor is realized in a simple structure, its product may be miniaturized. Also, adopting a CMOS technology may reduce the production cost and increase power consumption.

In general, an image sensor is realized in the form of a two-dimensional pixel array including a plurality of pixels therein. In the pixel array, a bad/defect pixel that does not normally react with respect to light may be formed due to diverse factors in the course of fabricating the image sensor.

In other words, the image sensor may have a pixel that does not normally operate due to various reasons in the course of the image sensor fabrication process, and there may be diverse reasons for it. Such an abnormal pixel does not normally operate with respect to light, and an image outputted from an image sensor including the abnormal pixel may display a deformed/distorted image which is different from an actual image. The bad pixel that does not normally operate with respect to light may show an image brighter or darker than its actual image. In particular, since the luminance difference between the bad pixel and adjacent pixels is greater than a predetermined threshold value, the bad pixel stands out.

Therefore, it may be said that the performance of the image sensor depends on the number of bad pixels included in the pixel array. A small speck or line may appear on a screen by a bad pixel in an image sensor. However, if an image sensor chip including such a partial defect is determined as a defective chip, the production throughput/yield of the image sensor may be decreased.

Therefore, it is desired to detect a bad pixel in a pixel array of an image sensor and improve the performance of the image sensor by correcting the detected bad pixel. Although there are many suggestions for detecting and correcting a bad pixel occurring in a pixel array of an image sensor, the suggested technologies have a limit to correct a bad pixel. Moreover, a high-capacity memory is required to correct a bad pixel. Therefore, a method for improving the performance of an image sensor by improving the correction coverage of a bad pixel even with a minimum-sized memory is useful.

### SUMMARY OF THE INVENTION

An embodiment of the present invention is directed to an image sensor which detects and corrects a bad pixel in a pixel array, and a method for detecting and correcting the bad pixel.

In accordance with an embodiment of the present invention, an image sensor includes: a corrector configured to receive a bayer raw data of a pixel array and output a corrected pixel value by correcting a dead pixel occurring in the pixel array; a memory configured to store the corrected pixel value updated in real-time; and a controller configured to control the real-time updating of the corrected pixel value to be stored in the memory, wherein when the corrector corrects the dead pixel in response to a clock, the corrector uses the corrected pixel value which is updated and stored in the memory in response to a previous cycle of the clock.

In accordance with another embodiment of the present invention, an image sensor includes: a memory configured to receive and stores a bayer raw data of a pixel array; a window former configured to form a window of a predetermined size in the pixel array; a first operator configured to perform a first operation of a bad pixel compensation operation onto the stored bayer raw data through the window; a second operator configured to perform a second operation of a bayer noise reduction operation onto the stored bayer raw data in parallel with the first operation through the window; and a third operator configured to perform a third operation of a Gr-Gb offset correction operation onto the stored bayer raw data by using one operation value between an operation value of the first operation and an operation value of the second operation.

In accordance with another embodiment of the present invention, an image sensor includes: a memory configured to receive a bayer raw data of a pixel array; a window former configured to form a window of a predetermined size in the pixel array; an operator configured to detect a dead pixel in the pixel array through the window, and perform a dead pixel correction operation onto the stored bayer raw data when the dead pixel is detected; and a processor configured to control the dead pixel correction operation and update an operation value of the dead pixel correction operation in real-time to the memory, wherein the operator performs the dead pixel correction operation onto the stored bayer raw data in response to a clock by using the operation value of the dead pixel correction operation which is updated and stored in the memory in a previous cycle of the clock.

In accordance with another embodiment of the present invention, a method for correcting a dead pixel in an image sensor includes: receiving and storing a bayer raw data of a pixel array; forming a window of a predetermined size in the pixel array by reading the stored bayer raw data; detecting and correcting a dead pixel occurring in the pixel array through the window; and updating and storing a corrected pixel value of the dead pixel in real-time, wherein in the detecting and correcting of the dead pixel occurring in the pixel array through the window, the dead pixel of the bayer raw data is corrected by using the corrected pixel value which is updated and stored in real-time.

In accordance with another embodiment of the present invention, a method for correcting a dead pixel in an image sensor includes: receiving and storing a bayer raw data of a pixel array; forming a window of a predetermined size in the pixel array by reading the stored bayer raw data; performing a bad pixel compensation operation and a bayer noise reduction operation in parallel onto the stored bayer raw data through the window; and performing a Gr-Gb offset correction operation onto the stored bayer raw data by using one operation value between an operation value of the bad pixel compensation operation and an operation value of the bayer noise reduction operation.

### BRIEF DESCRIPTION OF THE DRAWINGS

FIG. 1 illustrates a structure of an image sensor in accordance with an embodiment of the present invention.

FIG. 2 illustrates a structure of a conventional dead pixel corrector.

FIG. 3 illustrates a structure of a dead pixel corrector in accordance with an embodiment of the present invention.

FIG. 4 illustrates a structure of a dead pixel corrector in accordance with another embodiment of the present invention.

FIG. 5 is an operation timing diagram of the dead pixel corrector shown in FIG. 4.

FIG. 6 illustrates correction coverage of the dead pixel corrector shown in FIG. 4.

FIG. 7 illustrates correction coverage of a conventional dead pixel corrector.

FIG. 8 illustrates a structure of a dead pixel corrector shown in accordance with yet another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention provides an image sensor capable of detecting and correcting bad pixels, that is, multiple dead pixels, occurring in a pixel array including a plurality of pixels during an image signal processing (ISP) in a semiconductor device, and a method for correcting the multiple dead pixels. In an exemplary embodiment of the present invention, the size of a chip that realizes/embodies the image sensor is minimized by processing a corrected pixel value outputted from a dead pixel corrector during the image signal processing of the image sensor with a minimal use of a memory, and correcting multiple dead pixels detected through a shared pixel architecture, and minimizing the use of a line memory.

In an embodiment of the present invention, the correction coverage of a dead pixel corrector for correcting multiple dead pixels in the pixel array is increased, and the effect of correcting the multiple dead pixels is improved. Herein, the use of a memory for correcting the multiple dead pixels is minimized.

In an embodiment of the present invention, the effect of correcting the multiple dead pixels is improved by correcting dead pixels, which are bad/defect pixels, when the dead pixels are detected in the pixel array of an image sensor, updating the corrected pixel values into a memory in real-time, and performing a Bad Pixel Compensation (BPC) function and a Bayer Noise Reduction (BNR) function in parallel to correct the dead pixels.

Also, in an embodiment of the present invention, a line memory is used for a dead pixel corrector to correct pixels in a bayer raw data processing domain during the image signal process of the image sensor. Herein, the dead pixel corrector performs a bad pixel compensation function, a bayer noise reduction function, and a Gr-Gb offset correction function.

In an embodiment of the present invention, multiple dead pixels detected both in a shared pixel structure and single pixel structure are corrected. Also, an on-the-fly error correction operation function for real-time correction is improved.

Herein, in the exemplary embodiment of the present invention, the structures of line memories, each corresponding to each function of the dead pixel corrector of the image sensor, are improved to minimize the use of the memory. Accordingly, the chip size and chip fabrication cost of the image sensor are reduced. Generally, the bayer raw data processing domain during the image signal process of a CMOS image sensor means a digital region that is processed for the first time after an analog pixel data passes through an analog-to-digital converter.

The bayer raw data processing domain includes only one data among R, G and B data in one pixel data after an interpolation or demosaic process of the image signal processing, differently from an RGB (Red, Green and Blue) data region where R, G and B data are all completed in one pixel data. The image signal processing of the bayer raw data processing domain includes interpolation, black level correction, lens shading correction, dead pixel concealment, other than the bad pixel compensation, the bayer noise reduction, and the Gr-Gb offset correction. The bad pixel compensation function, the bayer noise reduction function, the Gr-Gb offset correction function, and the interpolation function require the use of the line memories.

In other words, in an embodiment of the present invention, when a dead pixel corrector processes a bayer raw data in a bayer domain, windows are controlled to be formed for the bad pixel compensation function, the bayer noise reduction function, and the Gr-Gb offset correction function, respectively, and the bad pixel compensation function, the bayer noise reduction function, and the Gr-Gb offset correction function are performed. In this way, the increase in the size of a chip of an image sensor caused by using the line memories to store output data of the respective functions is suppressed. Also, when multiple dead pixels are corrected in a shared pixel structure and a single pixel structure, the image distortion for each function of the dead pixel corrector is minimized.

To sum up, in the embodiment of the present invention, the memories corresponding to the bad pixel compensation function, the bayer noise reduction function, and the Gr-Gb offset correction function are realized into a single memory to reduce the size of a chip of the image sensor, and when a dead pixel is detected in the pixel array, the dead pixel is corrected and the corrected pixel value of the dead pixel is updated in real-time and stored. When multiple dead pixels are corrected, the pixel values read from the memory become pixel values in which a half the entire correction is reflected in order to form windows of the bad pixel compensation function, the bayer noise reduction function, and the Gr-Gb offset correction function.

Herein, as the corrected pixel values of the dead pixel correction are updated into the memory in real-time, windows are formed by reading the updated pixel values, that is, the corrected pixel values, from the memory so as to minimize the deterioration of each function of the dead pixel corrector, when the dead pixel corrector performs the bad pixel compensation function, the bayer noise reduction function, and the Gr-Gb offset correction function.

Herein, when the memories respectively corresponding to the bad pixel compensation function, the bayer noise reduction function, and the Gr-Gb offset correction function of the dead pixel corrector are realized into one memory without real-time update through the above-described memory controller, the respective functions of the dead pixel corrector may be deteriorated because the correction is not reflected in the pixel values read from the memory to form windows used in the bad pixel compensation function, the bayer noise reduction function, and the Gr-Gb offset correction function of the dead pixel corrector.

However, since real-time update is performed with the pixel values in which the correction is reflected through the memory controller, as described above in the embodiment of the present invention, the deterioration in the respective functions of the dead pixel corrector may be minimized.

Also, in the embodiment of the present invention, when bayer raw data are inputted, the bayer raw data inputted to form windows are stored in the line memory. The windows are formed by reading the bayer raw data stored in the line memory, and then the simultaneously read bayer raw data are inputted to perform the bad pixel compensation function and the bayer noise reduction function of the dead pixel corrector which is realized in a parallel structure.

Subsequently, respective operations are performed for the pixel data, that is, the bayer raw data, in the bad pixel compensation function and the bayer noise reduction function of the dead pixel corrector, and then when dead pixels are detected and a correction operation is performed, corrected pixel values are outputted through the Gr-Gb offset correction using the operation values of the bad pixel compensation function in the Gr-Gb function. When no dead pixels is detected and the correction function is not performed, corrected pixel values are outputted through the Gr-Gb offset correction using the operation value of the bayer noise reduction function in the Gr-Gb function.

Herein, when dead pixels are detected and the correction operation is performed, the corrected pixel values are simultaneously stored in the memory through memory update in real-time. The pixel values stored in the memory are used for the next operation of the bad pixel compensation in the dead pixel corrector so as to increase the correction coverage of dead pixels.

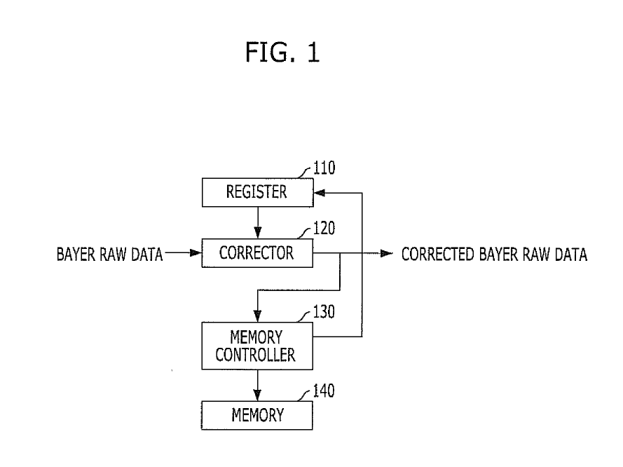

Hereafter, referring to FIG. 1, the dead pixel corrector of a semiconductor device is described in detail in accordance with an embodiment of the present invention.

FIG. 1 illustrates a structure of an image sensor in accordance with an embodiment of the present invention. FIG. 1 schematically shows a structure of the image sensor that corrects multiple dead pixels detected in a pixel array during the image signal processing of the image sensor.

Referring to FIG. 1, the image sensor includes a corrector 120, a memory 140, a memory controller 130, and a register 110. The corrector 120 processes inputted bayer raw data and corrects multiple dead pixels detected in a pixel array during the image signal processing. The memory 140 stores a corrected pixel values outputted from the corrector 120 in real-time. The memory controller 130 performs a control to update and store the corrected pixel values in the memory 140 in real-time. The register 110 stores the corrected pixel values in the current operation clock so that the corrector 120 uses the corrected pixel values for correction of multiple dead pixels detected in the next operation clock/cycle of the current operation clock.

The corrector 120 is the dead pixel corrector, which is described above. The corrector 120 stores a bayer raw data inputted during the image signal processing of the image sensor in the memory 140 according to an operation clock in order to form windows, forms the windows by reading the data stored in the memory 140, performs the bad pixel compensation function and the bayer noise reduction function in a parallel structure by detecting dead pixels occurring in the pixel array through the formed windows, and corrects the dead pixels in a predetermined operation clock by performing the Gr-Gb function.

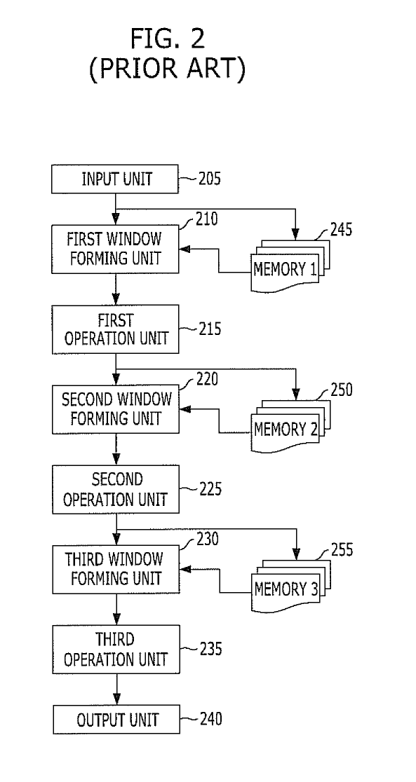

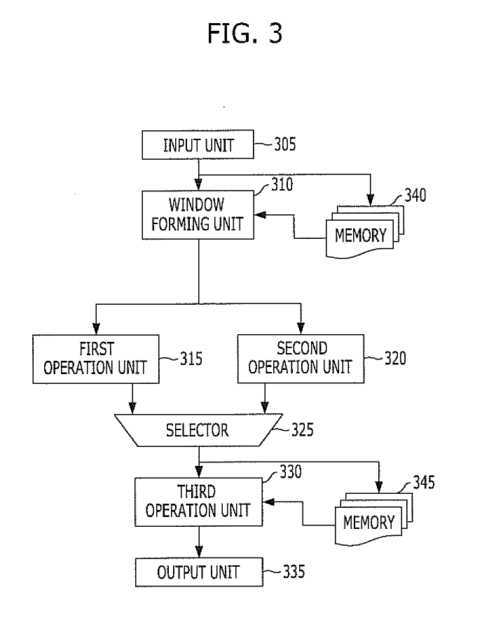

The memory controller 130 updates and stores the outputs of the corrector 120 as the pixel values corrected in the predetermined operation clock in the register 110 and the memory 140 in real-time. Herein, the corrected pixel values in the predetermined operation clock stored in the register 110 and the memory 140 are used for the corrector 120 to perform the above-described functions, thereby correcting the dead pixels detected in the pixel array in the next operation clock of the current operation clock. In short, the corrected pixel values are used for the bad pixel compensation function of the corrector 120. Hereafter, the dead pixel correction of the image sensor in a semiconductor device is described in detail with reference to FIGS. 2 and 3.

FIG. 2 illustrates a structure of a conventional dead pixel corrector. Herein, the dead pixel corrector for correcting dead pixels detected in the pixel array has a structure including a memory for each function.

Referring to FIG. 2, the dead pixel corrector of the image sensor includes an input unit 205, a first memory 245, a first window forming unit 210, and a first operation unit 215. The input unit 205 receives a bayer raw data as a pixel data. The first memory 245 stores the bayer raw data inputted as a pixel data. The first window forming unit 210 reads the bayer raw data stored in the first memory 245, that is, the pixel data, and forms a window in a pixel array. The first operation unit 215 performs a bad pixel compensation operation onto the bayer raw data of a dead pixel through the window formed by the first window forming unit 210.

The dead pixel corrector of the image sensor includes a second memory 250, a second window forming unit 220, and a second operation unit 225. The second memory 250 stores the bayer raw data obtained after the bad pixel compensation operation in the first operation unit 215. The second window forming unit 220 reads the bayer raw data stored in the second memory 250 and forms a window in a pixel array. The second operation unit 225 performs a bayer noise reduction operation onto the bayer raw data of pixels other than the dead pixel in the pixel array through the window formed by the second window forming unit 220.

Also, the dead pixel corrector of the image sensor includes a third memory 255, a third window forming unit 230, a third operation unit 235, and an output unit 240. The third memory 255 stores the bayer raw data obtained after the bayer noise reduction operation in the second operation unit 225. The third window forming unit 230 reads the bayer raw data stored in the third memory 255 and forms a window in the pixel array. The third operation unit 235 performs a Gr-Gb offset correction operation onto the bayer raw data of the pixel array with the Gr-Gb function through the window formed by the third window forming unit 230. The output unit 240 outputs a corrected pixel value obtained from the Gr-Gb offset correction operation of the third operation unit 235.

Herein, the first window forming unit 210 reads the pixel data, which is the bayer raw data stored in the first memory 245, and forms a window for detecting a dead pixel in the pixel array. The first operation unit 215 detects a dead pixel occurring in the pixel array through the window, performs a bad pixel compensation operation and outputs an operation value of the bad pixel compensation operation.

Also, the second window forming unit 220 reads the bayer raw data stored in the second memory 250 and forms the window for detecting the occurrence of a dead pixel in the pixel array. The second operation unit 225 performs a bayer noise reduction operation onto the bayer raw data of the pixel array and outputs an operation value of the bayer noise reduction operation, when no dead pixel is detected in the pixel array through the window.

The third window forming unit 230 reads the bayer raw data stored in the third memory 255 and forms a window for performing a Gr-Gb function in the pixel array. The third operation unit 235 performs a Gr-Gb offset correction operation onto the bayer raw data of the pixel array through the window and outputs a corrected pixel value of the Gr-Gb offset correction operation as a corrected pixel value.

The first window forming unit 210, the second window forming unit 220 and the third window forming unit 230 may form windows of the same size in the pixel array with the bayer raw data stored in the first memory 245, the second memory 250, and the third memory 255. According to an embodiment, they may form 5×5 windows, and windows of diverse sizes and different sizes may be formed according to the performance of the image sensor.

The dead pixel corrector of the image sensor illustrated in FIG. 2 includes the first memory 245, the second memory 250, and the third memory 255 for the bad pixel compensation function, the bayer noise reduction function, and the Gr-Gb offset correction function, respectively. Thus, the chip size of a chip constituting the image sensor and the chip fabrication cost thereof may be increased. In an embodiment of the present invention, the dead pixel corrector includes one memory for all of the functions, that is, one memory for the bad pixel compensation function, the bayer noise reduction function, and the Gr-Gb offset correction function.

FIG. 3 illustrates a structure of the dead pixel corrector in accordance with an embodiment of the present invention. Herein, the dead pixel corrector performing a dead pixel correction operation onto a dead pixel which is detected in the pixel array has a structure where it includes a memory corresponding to the multiple functions.

Referring to FIG. 3, the dead pixel corrector of the image sensor includes an input unit 305, a first memory 340, a window forming unit 310, and a first operation unit 315. The input unit 305 receives a bayer raw data as a pixel data. The first memory 340 stores the bayer raw data inputted to the input unit 305. The window forming unit 310 forms a window in a pixel array by reading the bayer raw data stored in the first memory 340, that is, the pixel data. The first operation unit 315 performs a bad pixel compensation operation onto the bayer raw data of a dead pixel detected in the pixel array through the window formed by the window forming unit 310.

The dead pixel corrector of the image sensor includes a second operation unit 320, a selector 325, a second memory 345, a third operation unit 330, and an output unit 335. The second operation unit 320 performs a bayer noise reduction operation onto the bayer raw data of pixels other than the dead pixel in the pixel array through the window formed by the window forming unit 310. The selector 325 selects and outputs any one between the output of the first operation unit 315 and the output of the second operation unit 320. The second memory 345 stores the bayer raw data obtained from the bad pixel compensation operation or the bayer noise reduction operation that is outputted by the selector 325. The third operation unit 330 performs a Gr-Gb offset correction operation onto the bayer raw data of the pixel array based on the output selected by the selector 325 with a Gr-Gb function. The output unit 335 outputs a pixel value corrected by the Gr-Gb offset correction operation of the third operation unit 330.

Herein, the window forming unit 310 forms the window for detecting a dead pixel in the pixel array by reading the pixel data, which is the bayer raw data stored in the first memory 340. The window forming unit 310 may form a window of a predetermined size in the pixel array of the bayer raw data stored in the first memory 340. According to an embodiment, the window forming unit 310 may form a 5×5 window, and windows of diverse sizes may be formed according to the performance of the image sensor.

The first operation unit 315 and the second operation unit 320 perform the bad pixel compensation operation and the bayer noise reduction operation, respectively, in a parallel structure through the window formed by the window forming unit 310.

In other words, when a dead pixel is detected in the pixel array through the above-formed window, the first operation unit 315 detects the dead pixel, performs the bad pixel compensation operation, and outputs an operation value of the bad pixel compensation operation. Also, when no dead pixel is detected in the pixel array through the above-formed window, the second operation unit 320 performs the bayer noise reduction operation onto the bayer raw data of the pixel array having no dead pixels, and outputs an operation value of the bayer noise reduction operation.

The selector 325 includes a multiplexing unit which selects and outputs any one input among a plurality of inputs according to a control signal. The selector 325 selects and outputs any one operation value between the operation value of the first operation unit 315 and the operation value of the second operation unit 320 according to a control signal determined based on whether or not there is a dead pixel in the pixel array.

In other words, the selector 325 selects and outputs an operation value of the bad pixel compensation operation outputted by the first operation unit 315 when a dead pixel is detected, and when no dead pixel is detected, the selector 325 selects and outputs an operation value of the bayer noise reduction operation outputted by the second operation unit 320.

The third operation unit 330 receives the operation value of the bad pixel compensation operation outputted by the first operation unit 315 or the operation value of the bayer noise reduction operation outputted by the second operation unit 320, performs the Gr-Gb offset correction operation onto the bayer raw data of the pixel array stored in the second memory 345 based on the received operation value, ad outputs a corrected pixel value of the pixel array obtained from the Gr-Gb offset correction operation.

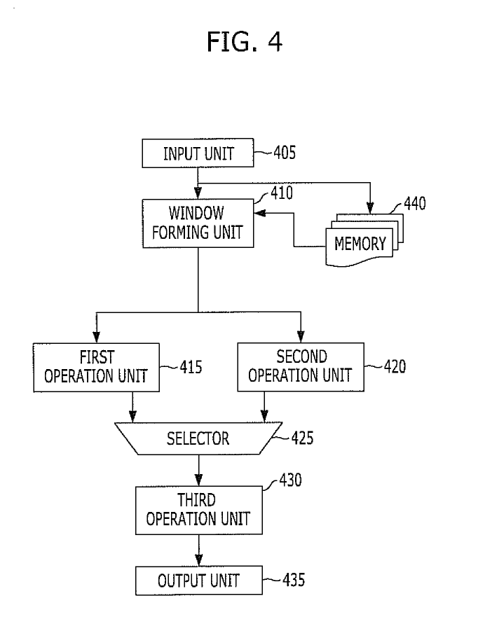

FIG. 4 illustrates a structure of the dead pixel corrector in accordance with another embodiment of the present invention. Herein, the dead pixel corrector which corrects a dead pixel detected in a pixel array includes one memory for all functions.

Referring to FIG. 4, the dead pixel corrector of the image sensor according to this embodiment of the present invention includes an input unit 405, one memory 440, a window forming unit 410, and a first operation unit 415. The input unit 405 receives a bayer raw data as a pixel data. The memory 440 stores the received bayer raw data. The window forming unit 410 forms a window in a pixel array by reading the bayer raw data stored in the memory 440, that is, the pixel data. The first operation unit 415 performs a bad pixel compensation operation onto the bayer raw data of dead pixels detected in the pixel array through the window formed by the window forming unit 410.

The dead pixel corrector of the image sensor includes a second operation unit 420, a selector 425, a third operation unit 430, and an output unit 435. The second operation unit 420 performs a bayer noise reduction operation onto the bayer raw data of pixels other than the dead pixel in the pixel array through the window formed by the window forming unit 410. The selector 425 selects and outputs one between an output of the first operation unit 415 and an output of the second operation unit 420. The third operation unit 430 performs a Gr-Gb offset correction operation onto the bayer raw data of the pixel array based on the output selected by the selector 425 with a Gr-Gb function. The output unit 435 outputs a corrected pixel value obtained from the Gr-Gb offset correction operation of the third operation unit 430.

Herein, the window forming unit 410 forms a window for detecting a dead pixel in a pixel array by reading the bayer raw data stored in the memory 440, which is the pixel data. The window forming unit 410 forms a window of a predetermined size in the pixel array of the bayer raw data stored in the memory 440, for example, a 5×5 window, and it may form windows of diverse sizes according to the performance of the image sensor.

The first operation unit 415 and the second operation unit 420 of a parallel structure perform the bad pixel compensation operation and the bayer noise reduction operation respectively through the window formed by the window forming unit 410. In other words, when a dead pixel is detected in the pixel array through the above-formed window, the first operation unit 415 detects the dead pixel and performs the bad pixel compensation operation and outputs an operation value of the bad pixel compensation operation.

Also, when no dead pixel is detected in the pixel array through the above-formed window, the second operation unit 420 performs the bayer noise reduction operation onto the bayer raw data whose pixels are not detected as a dead pixel and outputs an operation value of the bayer noise reduction operation. Herein, the bad pixel compensation operation of the first operation unit 415 and the bayer noise reduction operation of the second operation unit 420 are performed in parallel. In short, the first operation unit 415 and the second operation unit 420 are realized in a parallel structure.

Herein, the operation value of the bad pixel compensation operation outputted from the first operation unit 415 is updated and stored in the memory 140 and 440 and the register 110 as a corrected pixel value in real-time through the memory controller 130 as described above. In other words, the operation value of the bad pixel compensation operation is updated and stored in the memory 140 and 440 and the register 110 in real-time in each operation clock, and the operation value of the bad pixel compensation operation stored in a predetermined operation clock is referred to in the next operation clock of the predetermined operation clock when the first operation unit 415 detects a dead pixel occurring in the pixel array and performs a bad pixel compensation operation.

As described above, since the first operation unit 415 refers to the operation value of the bad pixel compensation operation in a previous operation clock when performing the bad pixel compensation operation in a current operation clock, the dead pixel correction coverage of the first operation unit 415 is increased.

The selector 425 includes a multiplexing unit which selects one among a plurality of inputs based on a control signal and outputs a selected input, and the selector 425 selects one between an operation value of the first operation unit 415 and an operation value of the second operation unit 420 upon receipt of a control signal decided based on whether or not there is a dead pixel in the pixel array and outputs the selected operation value.

In other words, when a dead pixel is detected, the selector 425 selects and outputs the operation value of the bad pixel compensation operation outputted from the first operation unit 415, and when no dead pixel is detected, the selector 425 selects and outputs the operation value of the bayer noise reduction operation outputted from the second operation unit 420.

The third operation unit 430 receives from the selector 425 the operation value of the bad pixel compensation operation outputted from the first operation unit 415 or the operation value of the bayer noise reduction operation outputted from the second operation unit 420, performs a Gr-Gb offset correction operation onto the bayer raw data of the pixel array based on the received operation value, and outputs the operation value of the Gr-Gb offset correction operation as a corrected pixel value of the pixel array.

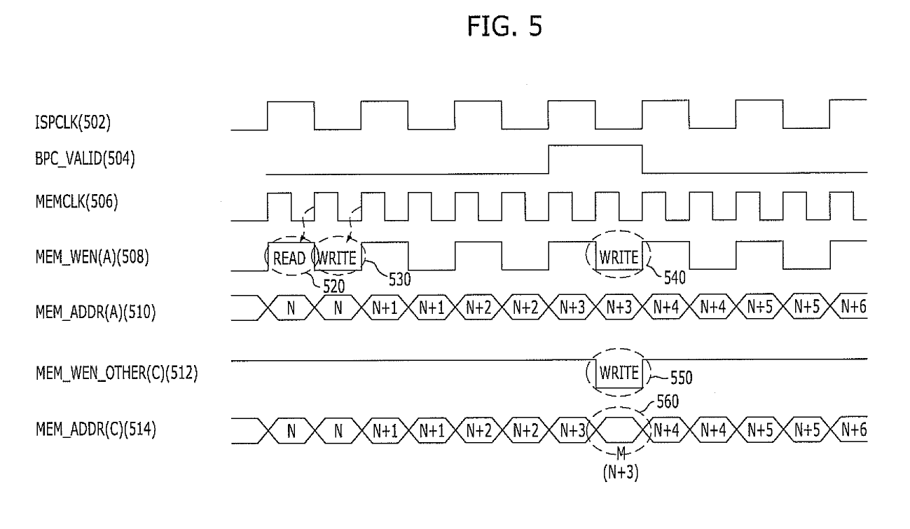

Hereafter, an operation of correcting a dead pixel in the image sensor of the semiconductor device according to the embodiment of the present invention is described in detail, with reference to FIG. 5.

FIG. 5 is an operation timing diagram of the dead pixel corrector shown in FIG. 4.

Referring to FIG. 5, the dead pixel corrector of the image sensor performs the above-described operation according to an operation clock ISPCLK 502. That is, the dead pixel corrector synchronizes the received bayer raw data with a memory clock MEMCLK 506, and writes (530/540) or reads (520) the bayer raw data in or from the memory according to a read/write signal MEM_WEN (A) 508 of a first memory in consideration of a first memory address MEM_ADDR(A) 510. Also, the dead pixel corrector of the image sensor reads (520) the bayer raw data stored in the memory, as described above, and performs the bad pixel compensation operation onto a dead pixel detected in the pixel array through the window formed in a predetermined size. Herein, the operation value of the bad pixel compensation operation is used for the Gr-Gb offset correction operation according to a control signal BPC_VALID 504, and also it is updated and stored in the memory or a register in consideration of a second memory address MEM_ADDR(C) 514 according to a second read/write signal MEM_WEN_OTHER(C) 512.

Herein, the operation value of the bad pixel compensation operation which is stored in the memory or the register is used for the bad pixel compensation operation of a dead pixel in the next operation clock, which is described above. The dead pixel corrector of the image sensor outputs a corrected pixel value obtained from the Gr-Gb offset correction operation, and since the dead pixel corrector uses the operation value obtained from the bad pixel compensation operation in one operation clock for a bad pixel compensation operation of a dead pixel performed in the next operation clock, the dead pixel correction coverage of the image sensor is increased.

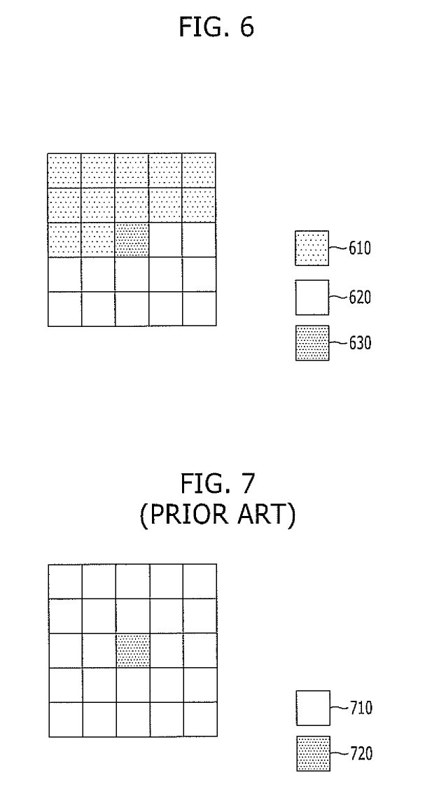

FIG. 6 illustrates correction coverage of the dead pixel corrector shown in FIG. 4, and FIG. 7 illustrates correction coverage of a conventional dead pixel corrector. FIG. 6 shows a case where a pixel correction in the current operation clock is performed using a pixel value of a corrected pixel in the previous operation clock in accordance with an embodiment of the present invention, and FIG. 7 shows a case where a pixel correction is individually performed for a corresponding pixel in each operation clock according to prior art without using a pixel value of a pixel corrected in the previous operation clock.

Referring to FIG. 6, as described above, the image sensor updates and stores a result value of the bad pixel compensation operation of the dead pixel corrector in a predetermined operation clock, that is, the operation value of the bad pixel compensation operation, in the register and the memory in real-time, and the image sensor performs a bad pixel compensation operation onto a dead pixel by using the stored operation value in the next operation clock after the predetermined operation clock.

For example, as the image sensor stores and uses the operation values of pixels 610 which performed the bad pixel compensation operation in the previous operation clock for a pixel 630 which perform the bad pixel compensation operation in the current operation clock in 25 pixels of a 5×5 window, the image sensor performs a correction onto a current pixel 630 by using the corrected pixel values of the 12 corrected pixels 610 among 24 pixels. On the other hand, the image sensor of FIG. 7 does not use the pixel value corrected in the previous operation clock but performs a correction individually onto the current pixel 720. Thus, since the dead pixel correction coverage is increased in accordance with the present invention than a case where all the other pixels except the current pixel 720 operate as uncorrected pixels 710, the performance of the image sensor is improved.

In other words, the image sensor according to one embodiment of the present invention updates and stores the corrected pixel value of the current operation clock in real-time in the memory and the register, and then it uses the stored pixel value when a dead pixel is corrected in the next operation clock. In this way, the image sensor may increase the dead pixel correction coverage in the pixel array. Also, since the functions needed for the dead pixel correction, such as the bad pixel compensation operation, the bayer noise reduction operation, and the Gr-Gb offset correction operation are realized in a single memory, the memory size may be decreased. In addition, the image sensor fabricated in accordance with an embodiment of the present invention realizes the memories for the respective functions for the dead pixel correction using one memory, the operations of storing and reading data in and from the memory may be reduced. Therefore, the operation speed of the image sensor is improved.

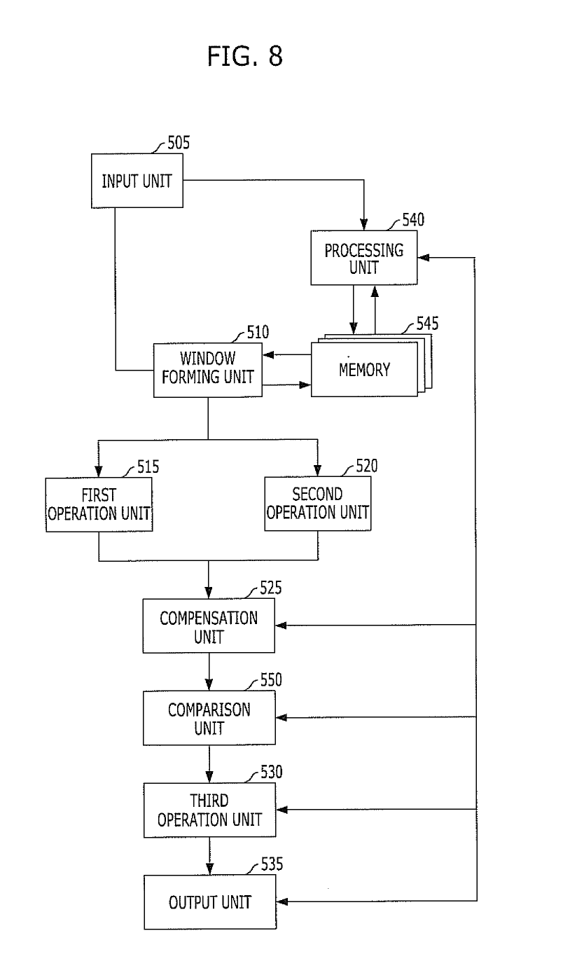

FIG. 8 illustrates a structure of a dead pixel corrector shown in accordance with yet another embodiment of the present invention. Herein, FIG. 8 schematically shows a structure where the dead pixel corrector which performs dead pixel correction in the pixel array includes a memory for each function.

Referring to FIG. 8, the dead pixel corrector of the image sensor includes an input unit 505, a memory 545, a window forming unit 510, and a first operation unit 515. The input unit 505 receives a bayer raw data as a pixel data. The memory 545 stores the received bayer raw data. The window forming unit 510 forms a window in a pixel array by reading the bayer raw data stored in the memory 545, that is, the pixel data. The first operation unit 515 performs a bad pixel compensation operation onto the bayer raw data of dead pixels detected in the pixel array through the window formed by the window forming unit 510.

The dead pixel corrector of the image sensor includes a second operation unit 520, a compensation unit 525, a comparison unit 550, a third operation unit 530, an output unit 535, and a processing unit 540. The second operation unit 520 performs a bayer noise reduction operation onto the bayer raw data of pixels other than the dead pixel in the pixel array through the window formed by the window forming unit 510. The compensation unit 525 receives an output of the first operation unit 515 and an output of the second operation unit 520 and performs a compensation operation. The comparison unit 550 checks the result of the compensation operation outputted from the compensation unit 525, that is, it checks whether a corrected pixel value is a pixel value obtained after a normal compensation operation. The third operation unit 530 performs a Gr-Gb offset correction operation onto the bayer raw data of the pixel array based on the output of the comparison unit 550 with a Gr-Gb function. The output unit 535 outputs a corrected pixel value obtained from the Gr-Gb offset correction operation of the third operation unit 530. The processing unit 540 controls and processes the correction operation of the dead pixel corrector of the image sensor, which is described in the above.

Herein, the processing unit 540 stores the received bayer raw data, and also stores a bayer raw data corresponding to the window formed by the window forming unit 510 in the pixel array and data information on the bayer raw data corresponding to the window. Herein, the bayer raw data corresponding to the window is stored in the memory 545 as well.

Also, the processing unit 540 controls the correction operation of the dead pixel corrector using the operation value of the bad pixel compensation operation outputted from the first operation unit 515 and the operation value of the bayer noise reduction operation outputted from the second operation unit 520.

The processing unit 540 outputs the stored bayer raw data corresponding to the window and the stored data information on the bayer raw data corresponding to the window to the compensation unit 525. The compensation unit 525 checks the correction on the bayer raw data corresponding to the occurrence of a dead pixel in the pixel array through the bayer raw data corresponding to the window and the data information on the bayer raw data corresponding to the window, and outputs the operation value of the bad pixel compensation operation or the operation value of the bayer noise reduction operation as a check result value.

Herein, when a dead pixel is detected in the pixel array and a correction operation is performed, the compensation unit 525 outputs the operation value of the bad pixel compensation operation as the result value of the correction operation through the bayer raw data corresponding to the window, and when no dead pixel is detected in the pixel array, the compensation unit 525 outputs the operation value of the bayer noise reduction operation as the result value of the correction operation.

The operation value of the bad pixel compensation operation and the operation value of the bayer noise reduction operation are updated, stored and managed in the processing unit 540 or the memory 545 in real-time.

The comparison unit 550 checks the output of the compensation unit 525 to see if the operation value of the bad pixel compensation operation or the operation value of the bayer noise reduction operation is a normal operation value. The checking is performed by comparing the above operation values with the operation values that have been updated, stored and managed in real-time in the processing unit 540 in the previous operation clock.

In other words, the comparison unit 550 checks whether or not the operation value of the bad pixel compensation operation or the operation value of the bayer noise reduction operation is a normal operation value by comparing the operation values outputted from the compensation unit 525 with the operation values that have been updated, stored and managed in real-time in the processing unit 540, and outputs the checked operation values to the third operation unit 530.

Herein, the window forming unit 510 forms a window for detecting a dead pixel in a pixel array by reading the bayer raw data stored in the memory 545, which is the pixel data. The window forming unit 510 forms a window of a predetermined size in the pixel array of the bayer raw data stored in the memory 545, for example, a N×N window, and it may form windows of diverse sizes according to the performance of the image sensor.

The first operation unit 515 and the second operation unit 520 of a parallel structure perform the bad pixel compensation operation and the bayer noise reduction operation respectively through the window formed by the window forming unit 510. In other words, when a dead pixel is detected in the pixel array through the above-formed window, the first operation unit 515 detects the dead pixel and performs the bad pixel compensation operation and outputs an operation value of the bad pixel compensation operation.

Also, when no dead pixel is detected in the pixel array through the above-formed window, the second operation unit 520 performs the bayer noise reduction operation onto the bayer raw data whose pixels are not detected as a dead pixel and outputs an operation value of the bayer noise reduction operation. Herein, the bad pixel compensation operation of the first operation unit 515 and the bayer noise reduction operation of the second operation unit 520 are performed in parallel. In short, the first operation unit 515 and the second operation unit 520 are realized in a parallel structure.

Herein, the operation value of the bad pixel compensation operation outputted from the first operation unit 515 is updated and stored in the memory 545 as a corrected pixel value in real-time as described above. In other words, the operation value of the bad pixel compensation operation is updated and stored in the memory 545 in real-time in each operation clock, and the operation value of the bad pixel compensation operation stored in a predetermined operation clock is referred to in the next operation clock of the predetermined clock when the first operation unit 515 detects a dead pixel occurring in the pixel array and performs a bad pixel compensation operation.

As described above, since the first operation unit 515 refers to the operation value of the bad pixel compensation operation in a previous operation clock when performing the bad pixel compensation operation in a current operation clock, the dead pixel correction coverage of the first operation unit 515 is increased.

The third operation unit 530 receives from the comparison unit 550 the operation value of the bad pixel compensation operation or the operation value of the bayer noise reduction operation, performs a Gr-Gb offset correction operation onto the bayer raw data of the pixel array based on the received operation value, and outputs the operation value of the Gr-Gb offset correction operation as a corrected pixel value of the pixel array.

The third operation unit 530 receives the bayer raw data of the pixel array from the processing unit 540 and performs the Gr-Gb offset correction operation. The operation value of the Gr-Gb offset correction operation is stored and managed in the processing unit 540 or the memory 545.

The dead pixel corrector of the image sensor according to the embodiment of the present invention described above stores the operation value of the bad pixel compensation operation in the memory 545, and as described above, the stored operation value of the bad pixel compensation operation is used when a bad pixel compensation operation of a dead pixel is performed in the next operation clock. The dead pixel corrector of the image sensor outputs a pixel value obtained after the Gr-Gb offset correction operation, and since an operation value obtained from the bad pixel compensation operation in one operation clock is used for a bad pixel compensation operation of a dead pixel performed in the next operation clock, the dead pixel correction coverage of the image sensor is improved.

According to the technology of the present invention, multiple dead pixels in a pixel array are detected during an image signal processing of a CMOS image sensor in a semiconductor device and the detected multiple dead pixels are corrected in parallel. Accordingly, the performance of the CMOS image sensor and the yield of the CMOS image sensor may be improved.

Also, the technology of the present invention, may reduce the size of a chip where the CMOS image sensor is realized and reduce production cost of the chip by minimizing the use of a memory during the correction of the multiple dead pixels detected in the pixel array.

While the present invention has been described with respect to the specific embodiments, it will be apparent to those skilled in the art that various changes and modifications may be made without departing from the spirit and scope of the invention as defined in the following claims.

What is claimed is:

1. An image sensor, comprising:
a corrector configured to receive a bayer raw data of a pixel array and output a corrected pixel value by correcting a dead pixel occurring in the pixel array;
a memory configured to store the corrected pixel value updated in real-time; and
a controller configured to control the real-time updating of the corrected pixel value to be stored in the memory,
wherein when the corrector corrects the dead pixel in response to a clock, the corrector uses the corrected pixel value which is updated and stored in the memory in response to a previous cycle of the clock.

2. The image sensor of claim 1, wherein the corrector comprises a window forming unit for forming a window of a predetermined size in the pixel array, and detects occurrence of the dead pixel in the pixel array through the window.

3. The image sensor of claim 2, wherein the corrector performs a bad pixel compensation (BPC) operation and a bayer noise reduction (BNR) operation in parallel onto the bayer raw data of the pixel array through the window.

4. The image sensor of claim 2, wherein the corrector comprises:
a first operation unit for performing a bad pixel compensation operation onto the dead pixel of the bayer raw data when the dead pixel is detected in the pixel array;
a second operation unit for performing a bayer noise reduction operation onto the bayer raw data when no dead pixel is detected in the pixel array; and
a third operation unit for performing a Gr-Gb offset correction operation onto the bayer raw data by using one operation value between an operation value of the first operation unit and an operation value of the second operation unit.

5. The image sensor of claim 4, wherein the corrector further comprises:
a selection unit for selecting the one operation value between the operation value of the first operation unit and the operation value of the second operation unit and outputting the selected operation value to the third operation unit according to the occurrence of the dead pixel in the pixel array.

6. The image sensor of claim 4, further comprising:
a register configured to update and store the operation value of the first operation unit as the corrected pixel value in real-time.

7. The image sensor of claim 4, wherein the number of the provided memory is one, and the memory stores the bayer raw data of the operations performed in the first operation unit, the second operation unit, and the third operation unit.

8. An image sensor, comprising:
a memory configured to receive and stores a bayer raw data of a pixel array;
a window former configured to form a window of a predetermined size in the pixel array;
a first operator configured to perform a first operation of a bad pixel compensation operation onto the stored bayer raw data through the window;
a second operator configured to perform a second operation of a bayer noise reduction operation onto the stored bayer raw data in parallel with the first operation through the window; and
a third operator configured to perform a third operation of a Gr-Gb offset correction operation onto the stored bayer raw data by using one operation value between an operation value of the first operation and an operation value of the second operation.

9. The image sensor of claim 8, wherein the first operator performs the first operation when a dead pixel is detected in the pixel array through the window.

10. The image sensor of claim 8, wherein the second operator performs the second operation when no dead pixel is detected in the pixel array through the window.

11. A method for correcting a dead pixel in an image sensor, comprising:
receiving and storing a bayer raw data of a pixel array;
forming a window of a predetermined size in the pixel array by reading the stored bayer raw data;
performing a bad pixel compensation operation and a bayer noise reduction operation in parallel onto the stored bayer raw data through the window; and
performing a Gr-Gb offset correction operation onto the stored bayer raw data by using one operation value between an operation value of the bad pixel compensation operation and an operation value of the bayer noise reduction operation.

12. The method of claim 11, wherein in the performing of the bad pixel compensation operation and the bayer noise reduction operation in parallel,
the bad pixel compensation operation is performed onto a dead pixel of the bayer raw data when the dead pixel is detected in the pixel array through the window.

13. The method of claim 11, wherein in the performing of the bad pixel compensation operation and the bayer noise reduction operation in parallel,
the bayer noise reduction operation is performed onto the stored bayer raw data when no dead pixel is detected in the pixel array through the window.

14. An image sensor, comprising:
a memory configured to store a bayer raw data of a pixel array;
a window former configured to form a window of a predetermined size in the pixel array;
an operator configured to detect a dead pixel in the pixel array through the window, and perform a dead pixel correction operation onto the stored bayer raw data when the dead pixel is detected; and
a processor configured to control the dead pixel correction operation and update an operation value of the dead pixel correction operation in real-time to the memory,
wherein the operator performs the dead pixel correction operation onto the stored bayer raw data in response to a clock by using the operation value of the dead pixel correction operation which is updated and stored in the memory in a previous cycle of the clock.

15. The image sensor of claim 14, further comprising:
a compensation unit configured to receive the bayer raw data corresponding to the window and data information from the processor, check whether the dead pixel is detected or not, and output one operation value between the first operation value and the second operation value.

16. The image sensor of claim 15, further comprising:
a comparator configured to check whether or not the operation value is a normally corrected operation value, and output the operation value to the third operation unit as the normally corrected operation value.

17. The image sensor of claim 16, wherein the comparator receives, from the processor, the operation value of the dead pixel correction operation which is updated and stored in real-time to the memory, and compares the operation value corresponding to the dead pixel correction operation in the certain clock with the stored operation value of the dead pixel correction operation.

18. A method for correcting a dead pixel in an image sensor, comprising:
receiving and storing a bayer raw data of a pixel array;
forming a window of a predetermined size in the pixel array by reading the stored bayer raw data;
detecting and correcting a dead pixel occurring in the pixel array through the window; and
updating and storing a corrected pixel value of the dead pixel in real-time,
wherein in the detecting and correcting of the dead pixel occurring in the pixel array through the window, the dead pixel of the bayer raw data is corrected by using the corrected pixel value which is updated and stored in real-time.

19. The method of claim 18, wherein in the detecting and correcting of the dead pixel occurring in the pixel array through the window,
a bad pixel compensation operation and a bayer noise reduction operation are performed in parallel onto the stored bayer raw data through the window.

20. The method of claim 18, wherein in the detecting and correcting of the dead pixel occurring in the pixel array through the window,
a predetermined operation according to whether or not a dead pixel occurs in the pixel array is performed through the window, and a Gr-Gb offset correction operation is performed onto the stored bayer raw data by using an operation value of the predetermined operation.

21. The method of claim 20, wherein in the detecting and correcting of the dead pixel occurring in the pixel array through the window,
a bad pixel compensation operation is performed onto the dead pixel of the bayer raw data as the predetermined operation when the dead pixel is detected in the pixel array through the window.

22. The method of claim 20, wherein in the detecting and correcting of the dead pixel occurring in the pixel array through the window,
a bayer noise reduction operation is performed onto the stored bayer raw data as the predetermined operation when no dead pixel is detected in the pixel array through the window.

23. The method of claim 19, wherein the detecting and correcting of the dead pixel occurring in the pixel array through the window comprises:
checking whether there is a dead pixel or not by using the window;
checking whether one operation value which is selected between an operation value of the bad pixel compensation operation and an operation value of the bayer noise reduction operation according to the check result of the dead pixel is a normally corrected operation value or not; and
performing a Gr-Gb offset correction operation onto the stored bayer raw data based on the checked operation value.

24. The method of claim 23, wherein whether the selected operation value is a normally corrected operation value or not is checked by comparing the corrected pixel value which is updated and stored in real-time with the selected operation value.
